(19) United States
(12) Patent Application Publication
(10) Pub. No.: US 2006/0072127 A1
(43) Pub. Date: Apr. 6, 2006

(54) System and method for image dependent black generation using the human contrast function's sensitivity to high frequencies in the luminous channel

(76) Inventor: Stephen K. Herron, Ladera Ranch, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/949,051

(22) Filed: Sep. 24, 2004

(51) Int. Cl. H04N 1/60

(52) U.S. Cl. 358/1.9

(57) ABSTRACT

The present invention is directed to a system and method for increasing the perception of detail in the highlight areas of a digital image during color space conversion using replacement of the gray component in a first color space to a second color space having a black component. Two gray component replacement lookup tables are generated and populated with black colorant amounts. A digital image is then segmented into two different regions, corresponding to one region having a high spatial frequency and one with normal distribution. A metadata map corresponding to pixel locations in the high frequency portions of the image is then generated. Each pixel group is then filtered to determine the amount of black colorant needed for gray component replacement. When the pixel group being filtered lies in the metadata map, the first lookup table is used, and the amount of colorant required is added to the lookup table in a new black channel. When the pixel group belongs in the region with normal distribution, the amount of colorant is written to the same black channel in the second lookup table. The neutral component of the first color space image is then removed and a second color space image is generated by combining the first color space image with the black channel.

### BACKGROUND OF THE INVENTION

This invention is directed to a system and method for gray component replacement in color space conversions. More particularly, this invention is directed to a system and method for increasing the perception of detail in the highlight areas of a digital image during color space conversion using replacement of the gray component in a first color space to a second color space.

A color space is a particular model of colors generally represented as a tri-dimensional map. The International Color Consortium profile format supports a variety of color spaces divided into three basic families, CIEXYZ, RGB and CMY. It should be noted that a subset of the CIEXYZ spaces are also defined as connection spaces. CIELAB, or “CIE L*a*b*” color gets its name from a color space that uses three values to describe the precise three-dimensional location of a color inside a visible color space CIE stands for Commission Internationale de l-Eclairages an international body of color scientists whose standards make it possible to communicate color information accurately “L*” describes relative lightness, “a*” represents relative redness-greenness, and “b*” represents relative yellowness-blueness. The CIEXYZ structure contains the x, y, and z coordinates of a specific color in a specified color space.

A color model that describes each color in terms of the quantity of each secondary color, cyan, magenta, yellow, and black is commonly referred to as the CMYK color model. The CMYK system is used for printing. For mixing of pigments, it is better to use the secondary colors, since they mix subtractively instead of additively. The secondary colors of light, cyan, magenta and yellow, correspond to the primary colors of pigment (blue, red and yellow). In addition, although black could be obtained by mixing these three in equal proportions, in four-color printing, black is typically used as a separate colorant. The K in CMYK stands for ‘Key’ or ‘blacK,’ so as not to cause confusion with the B in RGB (Red, Green, Blue).

As will be known in the art, the difference between the two color models is based on how color is produced. Red, green, and blue are projected light and cyan, magenta, yellow, and black is reflected light. Combining varying amounts of red, green and blue will faithfully create the *spectrum of colors. By varying the amounts of red, green and blue, an image may be projected onto the phosphors of a monitor or television screen. However, pigments added to paper, successively, will darken the paper. Using selective light colors will recreate the spectrum on white paper. Thus, cyan will absorb red, magenta will absorb green and yellow will absorb blue. These are called the subtractive primary colors, or secondary colors. Because of the lightness of cyan, magenta and yellow, black, is use for the gray components. Using CYMK is commonly referred to as Four Color Processing.

When producing gray values with four ink colors, such as CMYK, substantial savings in ink are obtained by replacing portions of the cyan, magenta and yellow inks with black ink. Two methods are used to replace these portions of cyan, yellow and magenta inks with black ink: Under Color Removal (“UCR”) and Gray Component Replacement (“GCR”). When using UCR, a single black ink is used for any shade of gray produced by a cyan, magenta, yellow in shadow portions of the image. GCR increases the amount of black ink used in gray reproduction while simultaneously reducing the amounts of cyan, magenta and yellow inks consumed. GCR substitutes black ink for equal components of cyan, magenta and yellow in any portion of the image. The use of this 1 for 3 replacement results in a reduction by ⅔ of ink consumption for any given portion of the image. The reduction in ink use results in less ink coverage overall, enabling easier gray balance, better run stability and color consistency, and faster printing.

The typical GCR process replaces the neutral component of a cyan-magenta-yellow (“CMY”) color with a proportional amount of black (“K”). The CMY combination selected for conversion to CMYK is based on a function of the amount of gray within the trichromatic combination. Current GCR algorithms governing the replacement of cyan, yellow, magenta inks with black ink are not image specific. Thus, in color conversion from CMY to CMYK, highlight areas near the neutral axis, i.e., “L” of CIE L*a*b* color space, containing high spatial frequencies are not normally processed, i.e., replaced with black ink.

Thus, there is a need for a system and method for gray component replacement of highlight areas in color conversion processing.

### SUMMARY OF THE INVENTION

The present invention is directed to a method and system for increasing the perception of detail in the highlight areas of a digital image during color space conversion using replacement of the gray component in a first color space to a second color space.

In accordance with the present invention, there is provided a system for gray component replacement in a first color space to a second color space color conversion. The system includes means adapted for receiving a first color space image into a gray component replacement means. The gray component replacement means includes first and second gray component replacement schemes. The system also includes segmenting means adapted for segmenting the first color space image into two image file segments. The first file segment is associated with a first defined spatial frequency range while the second file segment is associated with a second spatial frequency range, independent from the first frequency range. The first image file segment is communicated, via communications means, to the first gray component replacement scheme. The second file segment is communicated, via communications means, to the second gray component replacement scheme. The system also includes means adapted for outputting a second color space image according to the output from the first and second replacement schemes.

In one embodiment, the system uses a first lookup table corresponding to the first replacement scheme and a second lookup table corresponding to the second replacement scheme. The first lookup table is populated by a first set of replacement values. The second replacement scheme uses a second lookup table populated with a second set of replacement values. In another embodiment, the system further includes means adapted for selectively removing data representing a neutral component from the first color space or second color space digital image files prior to outputting of the second color space encoded digital image file associated therewith.

Further, in accordance with the present invention, there is provided a method for gray component replacement in a first color space to second color space color conversion. The method includes the step of receiving a first color space encoded digital image file into a gray component replacement means, which includes first and second gray component replacement schemes. The method also includes the step of segmenting the first color space image file into two image file segments, with the first image file segment associated with image data having a first spatial frequency. The second image file segment is associated with image data having a second spatial frequency, unique from the first spatial frequency. Next, the first image file segment is communicated to the first gray component replacement scheme and the second image file segment is communicated to the second gray component replacement scheme. A second color space encoded digital image file is then output according to the output of the gray component replacement means.

In a preferred embodiment, the first gray component replacement scheme employs a first lookup table populated with a first set of replacement values, and the second gray component replacement scheme employs a second lookup table populated with a second set of replacement values. In one embodiment, the method further includes the step of selectively removing neutral component data from the first color space image file prior to outputting the second color space encoded digital image file. In a preferred embodiment, the method further includes the steps of associating each pixel of the image with one of the image file segments and filtering the pixels in groups based on their association with the image file segments.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The subject invention is described with reference to certain parts, and arrangements to parts, which are evidenced in conjunction with the associated drawings, which form a part hereof and not, for the purposes of limiting the same in which:

FIG. 1 is a block diagram illustrative of the system of the present invention;

FIG. 2 is a flowchart illustrating the CMY to CMYK conversion process according to the present invention;

FIG. 3 is an illustration depicting the three-dimensional lookup tables according to the present invention;

FIG. 4 is an illustration depicting the black generation curves of gray component replacement according to the present invention;

FIG. 5 is an illustration of a comparison of gray component replacement according to the present invention;

FIG. 6 is an exemplary illustration depicting black generation; and

FIG. 7 is an exemplary illustration depicting a comparison of low-frequency black generation with high frequency black generation.

### DETAILED DESCRIPTION OF THE PREFERRED EMBODIMENT

This invention is directed to a system and method for gray component replacement in color space conversions. In particular, this invention is directed to a system and method for increasing the perception of detail in the highlight areas of a digital image during color space conversion using replacement of the gray component in a first color space to a second color space inclusive of a black component. In the preferred embodiment, as described herein, the first color space is suitably a cyan-magenta-yellow color space and the second color space is suitably a cyan-magenta-yellow-black color space. The skilled artisan will appreciate that other color spaces are equally capable of being employed, without departing from the scope of the invention.

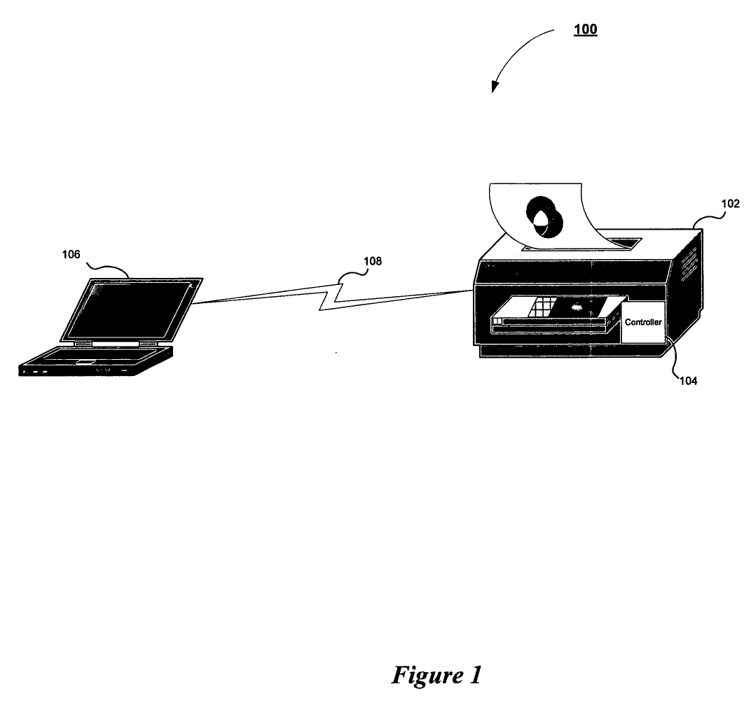

Turning now to the drawings wherein the illustrations are for illustrating the preferred embodiment only, and not for delivering the same. A diagram illustrating the system 100 is shown in FIG. 1. In the present invention, a user is provided access to a document processing device 102. Preferably, the document processing device is an image generating device as is known in the art. Preferably, the image generating device is a scanning device, a copying device, a facsimile device, or a multifunctional peripheral device. More preferably, the image generating device is a multifunction peripheral device. Suitable commercially available image generating devices include, but are not limited to, the Toshiba e-Studio Series Controller. The image generating device further comprises a controller 104 which controls the functions of the image generating device.

In one embodiment, the user accesses the multifunctional peripheral device 102 via a computer or document data device 106 via a suitable communication link 108. In another embodiment, the user accesses the multifunctional peripheral device via a mobile or wireless device and connects using at least one of BlueTooth™ standard, 802.11(x) and other 802.11 compliant devices. It is understood by one of skill in the art that neither the multifunctional peripheral device nor the computer have to be in continuous data communication with each other in order for the present invention to effectively function. Either or both the multifunctional peripheral device and the document data device are suitably communicate with each other intermittently, transmitting and receiving information in batch mode.

Preferably, the multifunction peripheral device 102 suitably includes means adapted to employ the method of the present invention. It will be understood by those skilled in the art that the subject invention is capable of being implemented via hardware, e.g., an application specific integrated circuit, or via software, e.g., any programming language known in the art. The multifunction peripheral device 102 suitably includes communications means adapted for receiving digital images via the computer or document data device 106, or via other input means available on the multifunction peripheral device 102. The skilled artisan will appreciate that a microprocessor or other control device, such as the controller 104, are equally adapted to employ the present invention, using the method set forth below.

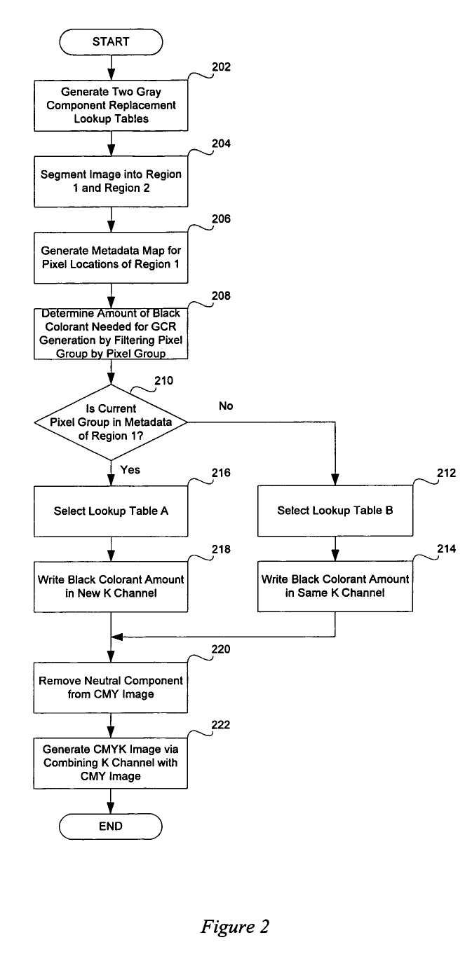

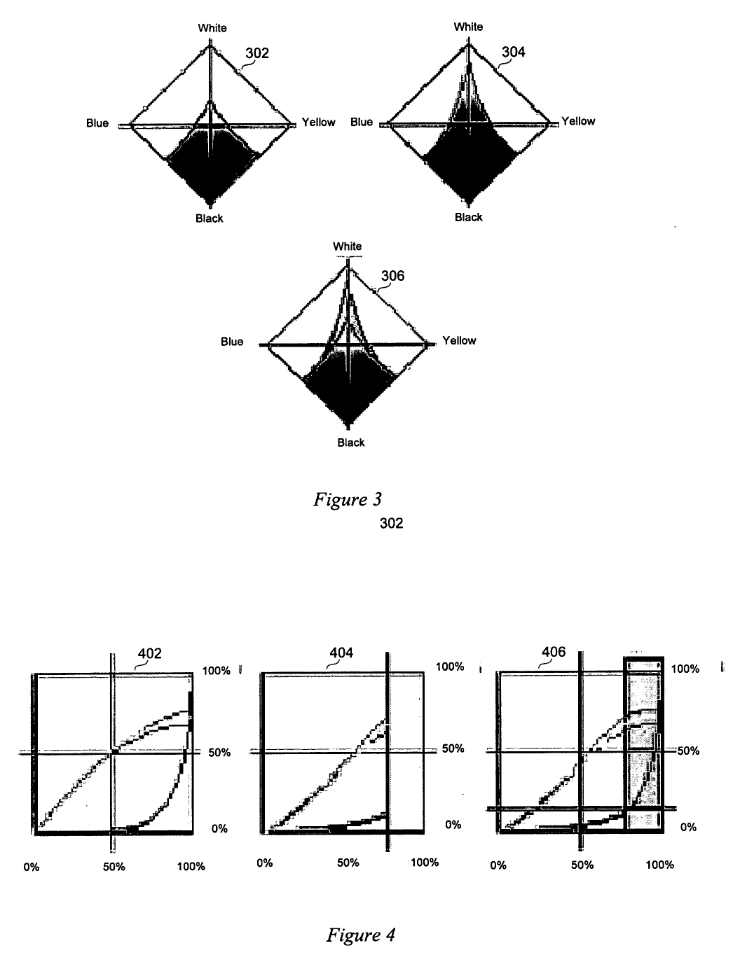

Referring now to FIGS. 2 and 3, there is illustrated a color conversion method of the present invention. The method for converting a CMY image to a CMYK image begins at step 202 where two or more gray component replacement three-dimensional lookup tables, Lookup Table A 302 and Lookup Table B 304, are generated. For explanatory purposes only, the subject invention uses two gray component replacement lookup tables, however the skilled artisan will appreciate that more than two tables are capable of being employed without departing from the scope of the invention. Lookup table A 302 represents a normal lookup table, e.g., a lookup table recognizable to one skilled in the art as lacking gray component replacement in the highlight portions of a given image. The second lookup table, Lookup Table B 304, displays a gray component replacement in the highlights. The skilled artisan will appreciate that the highlights, as used herein, refers to those portions of a digital image containing higher spatial frequencies.

It will also be understood by those skilled in the art that a lookup table, such as tables A and B, are more flexible than traditional black generation curves. FIG. 4 illustrates a traditional black generation curve for a traditional gray component replacement method 402, the gray component replacement method 404 of the high spatial frequency area of the present invention, and the combined gray component replacement in an image 406 using both the traditional and present gray component replacement methods. The actual cone shape is typically a very complex shape defining colorant mixtures that require black generation. The Lookup Tables A 302 and B 304 employ “fuzzy” edges, enabling a smooth merge between the two cone shapes, shown in the combined lookup table 306. The skilled artisan will appreciate that the use of cones in the lookup tables is for illustration purposes only and other formats of the lookup tables are equally capable of being used without departing from the subject invention.

The method continues to step 204, where the image is segmented into two distinct regions. The method employs a high frequency spatial search algorithm with a neutral search algorithm to produce the two segments of the image. It will be understood by those skilled in the art that the search algorithms employed by the present invention are any suitable search algorithms known in the art. Region 1 contains high spatial frequencies in neutral tones of highlights and Region 2 contains the remaining portion of the image where any gray component replacement known in the art is suitably applied. At step 206, a metadata map designating the pixel locations of Region 1 is generated using any known means. At step 208, the image is surveyed with a filter, pixel group by pixel group, to obtain the amount of black colorant needed for the gray component replacement, thereby generating a K channel. At step 210, a determination is made whether the current pixel group is located in the metadata map, denoting its presence in Region 1.

When the current pixel group is not in Region 1, the method proceeds to select the lookup table B at step 212. The black colorant amount is then written in the Lookup Table B in the same K channel at step 214. The neutral component is then removed from the CMY image at step 220 using any gray component replacement method known in the art. For example, a color defined as 4% cyan, 62% magenta and 84% yellow is colormetrically equivalent to a color defined as 2% cyan, 60% magenta, 82% yellow and 2% black. The skilled artisan will appreciate that the replacement of the neutral component with a corresponding amount of black colorant increases the visibility of the high frequencies without negatively impacting color accuracy. A CMYK image is then generated at step 222 by combining the same K channel with the CMY image.

When the current pixel group is located in Region 1, the lookup table A is selected at step 216. Following the selection of Lookup Table A, the amount of black colorant is written in Lookup Table A in a new K channel at step 218. The neutral component of the CMY image is then removed at step 220. The removal of the neutral component of the CMY image at step 220 is accomplished using any known gray component replacement algorithm known in the art. The final CMYK converted image is then output by combining the new K channel with the CMY image at step 222. The skilled artisan will appreciate that the employment of the aforementioned method replaces more of the expensive color inks with the less expensive black ink.

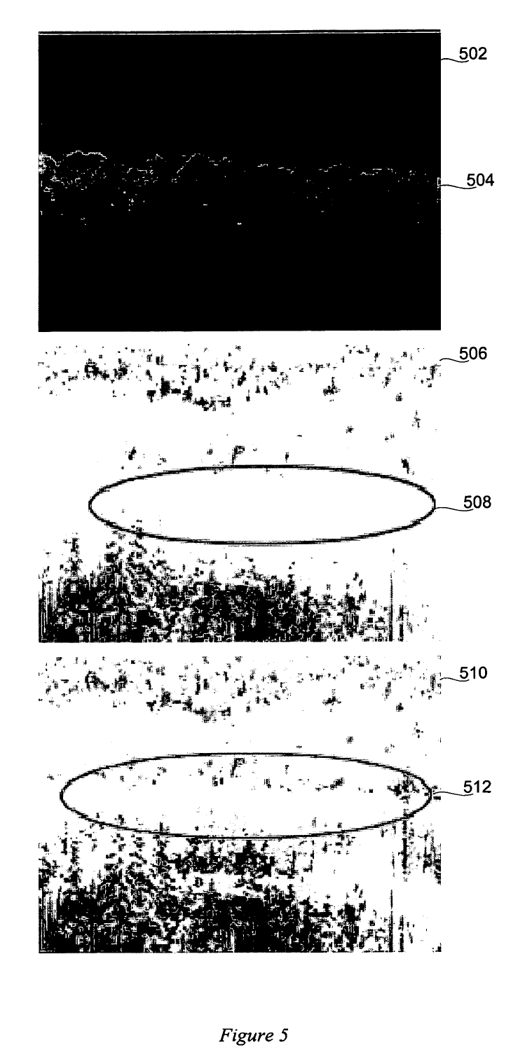

Referring now to FIG. 5, there is illustrated a comparison between gray component replacement using traditional methods and gray component replacement using the present invention. As shown in FIG. 5, the picture 502 contains a high spatial frequency area 504 located at the center of the image to be processed. As will be understood by the skilled artisan, when applying traditional gray component replacement methods, the image is converted to the picture 506. It will be apparent to those skilled in the art that the high spatial frequency area 508 of picture 506 is noticeably indistinct. In contrast, the picture 512 applying the method of the present invention uses gray component replacement on the high spatial frequency area 514, thereby increasing the perception of detail in the highlight area.

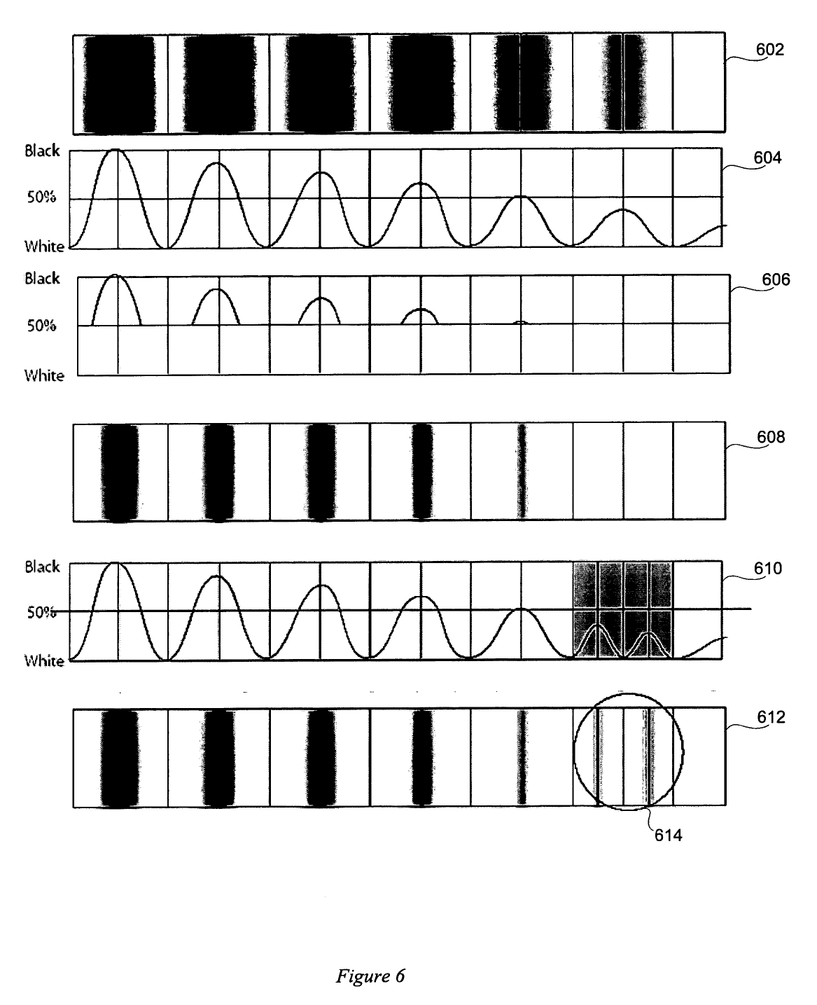

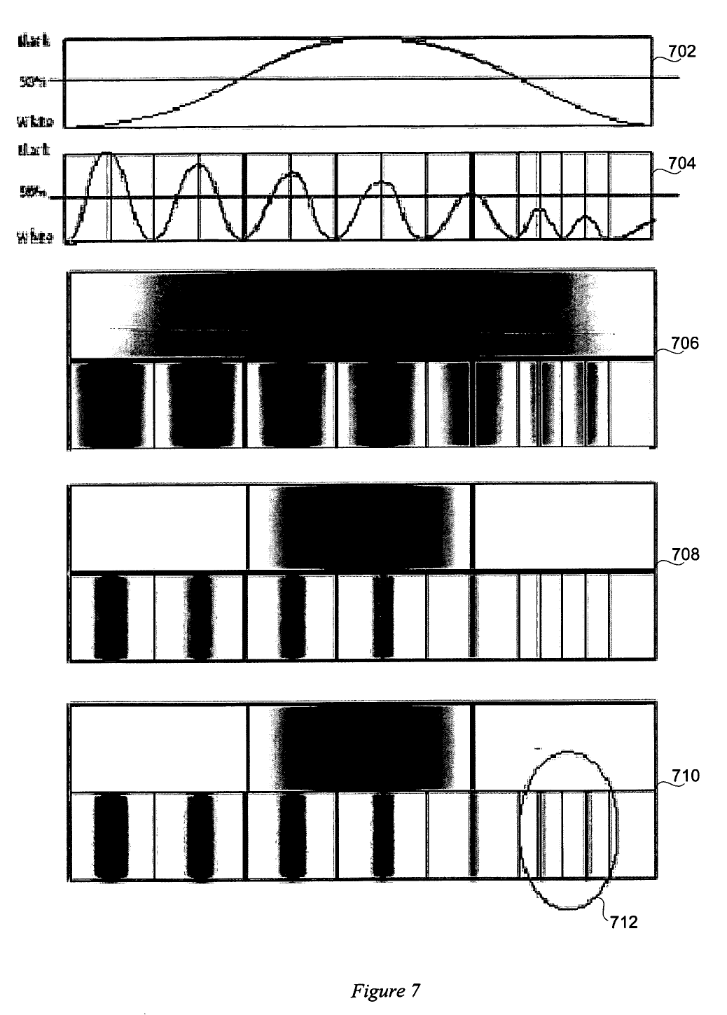

Turning now to FIG. 6, there is shown an exemplary illustration depicting black generation. The image 602 represents a sliding increase in frequency of tonal levels, going from darker to lighter, signify an increase in the gray component of the image. The gradient curve display 604 illustrates the tonal values, ranging from black to white, with typical gray component replacement occurring at the fifty percent level, shown as 606. It will be noted by the skilled artisan that typical portions of tonal level requiring traditional black generation begin at fifty percent. The skilled artisan will appreciate that the illustrations of FIGS. 6 and 7 are for example purposes only, and should not be construed to limit application of the present invention to only the fifty percent tone.

A grayscale representation of traditional black generation beginning at the fifty percent tone is shown at 608. At 610, a grayscale representation of black generation is shown with the high-frequency component illustrated in the gray area to the right of the representation 610. The result of applying the foregoing method to the representation 602 is illustrated as 612, with the new high-frequency generation 614 at the far right. The skilled artisan will appreciate that the when applying the present invention to the representation 602, the detail surrounding the far right of the representation 602 increases in perception, enabling a sharper image to be viewed.

The illustrations of FIG. 6 will be better understood when viewing the illustrations shown in FIG. 7. Referring now to FIG. 7, there is shown an exemplary illustration depicting a comparison of low-frequency black generation with high frequency black generation. Gradient curves 702 and 704 depict typical tonal levels of a given image. A grayscale representation of the curves is depicted at 706, illustrating the combined traditional gray component replacement at the fifty percent level combined with the gray component replacement of the high spatial frequency portion according to the present invention. Thus, traditional black generation at the fifty percent level is illustrated at 708, absent the gray component replacement at the higher frequencies, e.g., the lighter area to the right of the scale 708. The application of the present invention is visible in the combined grayscale 710. The result of the high spatial frequency gray component replacement 712, shown in the scale 710, illustrates the application of gray component replacement to areas that traditional gray component methods would ignore.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A system for gray component replacement in a first color space to a second color space color conversion comprising:
means adapted for receiving a first color space encoded digital image file into a gray component replacement means, which gray component replacement means includes first and second gray component replacement schemes defined therein;
segmenting means adapted for segmenting the first color space encoded digital image file into first and second image file segments, wherein the first image file segment is associated with image data having a first defined spatial frequency range and the second image file is associated with image data having a second, spatial frequency range defined uniquely to the first spatial frequency range;
means adapted for communicating the first image file segment to the first gray component replacement scheme;
means adapted for communicating the second image file segment to the second gray component replacement scheme; and
means adapted for outputting a second color space encoded digital image file in accordance with the output of the gray component replacement means.

2. The system for gray component replacement in a first color space to a second color space color conversion of claim 1, wherein:
the first gray component replacement scheme employs a first lookup table, wherein the first lookup table is populated with a first set of replacement values; and
the second gray component replacement scheme employs a second lookup table populated with a second set of replacement values.

3. The system for gray component replacement in a first color space to a second color space color conversion of claim 2, further comprising means adapted for selectively removing data representative of a neutral component from at least one of the first color space and second color space digital image files prior to outputting of the second color space encoded digital image file associated therewith.

4. The system for gray component replacement in a first color space to a second color space color conversion of claim 3 wherein:
the gray component replacement means includes at least a third gray component replacement scheme; and
the segmenting means includes means for segmenting, in accordance with a unique spatial frequency range relative to every other spatial frequency range, the first color space encoded digital image file into at least a third image file segment communicated to the third gray component replacement scheme.

5. The system for gray component replacement in a first color space to a second color space color conversion of claim 1, wherein the second color space includes a black component.

6. The system for gray component replacement in a first color space to a second color space color conversion of claim 1, wherein the first color space is a cyan-magenta-yellow color space, and wherein the second color space is a cyan-magenta-yellow-black color space.

7. The system for gray component replacement in a first color space to a second color space color conversion of claim 1, further comprising:
means adapted for associating each of a plurality of pixels of the first color space image with one of the first and second image file segments; and
means adapted for filtering the plurality of pixel groups based upon the association with one of the first and second image file segments.

8. The system for gray component replacement in a first color space to a second color space color conversion of claim 7, further comprising means adapted for determining an amount of black colorant required for gray component replacement in each of the first and second gray component replacement schemes.

9. A method for gray component replacement in a first color space to a second color space color conversion comprising the steps of:
receiving a first color space encoded digital image file into a gray component replacement means, which gray component replacement means includes first and second gray component replacement schemes defined therein;
segmenting the first color space encoded digital image file into first and second image file segments, wherein the first image file segment is associated with image data having a first defined spatial frequency range and the second image file is associated with image data having a second, spatial frequency range defined uniquely to the first spatial frequency range;
communicating the first image file segment to the first gray component replacement scheme;
communicating the second image file segment to the second gray component replacement scheme; and
outputting a second color space encoded digital image file in accordance with the output of the gray component replacement means.

10. The method for gray component replacement in a first color space to a second color space color conversion of claim 9, wherein:
the first gray component replacement scheme employs a first lookup table, wherein the first lookup table is populated with a first set of replacement values; and
the second gray component replacement scheme employs a second lookup table populated with a second set of replacement values.

11. The method for gray component replacement in a first color space to a second color space color conversion of claim 10, further comprising the step of selectively removing data representative of a neutral component from at least one of the first color space and second color space digital image files prior to outputting of the second color space encoded digital image file associated therewith.

12. The method for gray component replacement in a first color space to a second color space color conversion of claim 11 wherein:
the gray component replacement means includes at least a third gray component replacement scheme; and
the segmenting the first color space encoded digital signal further includes segmenting, in accordance with a unique spatial frequency range relative to every other spatial frequency range, the first color space encoded digital image file into at least a third image file segment communicated to the third gray component replacement scheme.

13. The method for gray component replacement in a first color space to a second color space color conversion of claim 9, wherein the second color space includes a black component.

14. The method for gray component replacement in a first color space to a second color space color conversion of claim 9, wherein the first color space is a cyan-magenta-yellow color space, and wherein the second color space is a cyan-magenta-yellow-black color space.

15. The method for gray component replacement in a first color space to a second color space color conversion of claim 9, further comprising the steps of:
associating each of a plurality of pixels of the first color space image with one of the first and second image file segments; and
filtering the plurality of pixel groups based upon the association with one of the first and second image file segments.

16. The method for gray component replacement in a first color space to a second color space color conversion of claim 15, further comprising the step of determining an amount of black colorant required for gray component replacement in each of the first and second gray component replacement schemes.

17. A computer readable medium of instructions for gray component replacement in a first color space to a second color space color conversion comprising the steps of:
instructions for receiving a first color space encoded digital image file into a gray component replacement means, which gray component replacement means includes first and second gray component replacement schemes defined therein;
instructions for segmenting the first color space encoded digital image file into first and second image file segments, wherein the first image file segment is associated with image data having a first defined spatial frequency range and the second image file is associated with image data having a second, spatial frequency range defined uniquely to the first spatial frequency range;
instructions for communicating the first image file segment to the first gray component replacement scheme;
instructions for communicating the second image file segment to the second gray component replacement scheme; and
instructions for outputting a second color space encoded digital image file in accordance with the output of the gray component replacement means.

18. The computer readable medium of instructions for gray component replacement in a first color space to a second color space color conversion of claim 17, wherein:
the first gray component replacement scheme employs a first lookup table, wherein the first lookup table is populated with a first set of replacement values; and
the second gray component replacement scheme employs a second lookup table populated with a second set of replacement values.

19. The computer readable medium of instructions for gray component replacement in a first color space to a second color space color conversion of claim 18, further comprising instructions for selectively removing data representative of a neutral component from at least one of the first color space and second color space digital image files prior to outputting of the second color space encoded digital image file associated therewith.

20. The computer readable medium of instructions for gray component replacement in a first color space to a second color space color conversion of claim 19 wherein:
the gray component replacement means includes at least a third gray component replacement scheme; and
the instructions for segmenting the first color space encoded digital signal further includes instructions for segmenting, in accordance with a unique spatial frequency range relative to every other spatial frequency range, the first color space encoded digital image file into at least a third image file segment communicated to the third gray component replacement scheme.

21. The computer readable medium of instructions for gray component replacement in a first color space to a second color space color conversion of claim 17, wherein the second color space includes a black component.

22. The computer readable medium of instructions for gray component replacement in a first color space to a second color space color conversion of claim 17, wherein the first color space is a cyan-magenta-yellow color space, and wherein the second color space is a cyan-magenta-yellow-black color space.

23. The computer readable medium of instructions for gray component replacement in a first color space to a second color space color conversion of claim 17, further comprising:
instructions for associating each of a plurality of pixels of the first color space image with one of the first and second image file segments; and
instructions for filtering the plurality of pixel groups based upon the association with one of the first and second image file segments.

24. The computer readable medium of instructions for gray component replacement in a first color space to a second color space color conversion of claim 23, further comprising instructions for determining an amount of black colorant required for gray component replacement in each of the first and second gray component replacement schemes.

25. A computer implemented method for gray component replacement in a first color space to a second color space color conversion comprising the steps of:
receiving a first color space encoded digital image file into a gray component replacement means, which gray component replacement means includes first and second gray component replacement schemes defined therein;
segmenting the first color space encoded digital image file into first and second image file segments, wherein the first image file segment is associated with image data having a first defined spatial frequency range and the second image file is associated with image data having a second, spatial frequency range defined uniquely to the first spatial frequency range;
communicating the first image file segment to the first gray component replacement scheme;
communicating the second image file segment to the second gray component replacement scheme; and
outputting a second color space encoded digital image file in accordance with the output of the gray component replacement means.

26. The computer implemented method for gray component replacement in a first color space to a second color space color conversion of claim 25, wherein:
the first gray component replacement scheme employs a first lookup table, wherein the first lookup table is populated with a first set of replacement values; and
the second gray component replacement scheme employs a second lookup table populated with a second set of replacement values.

27. The computer implemented method for gray component replacement in a first color space to a second color space color conversion of claim 26, further comprising the step of selectively removing data representative of a neutral component from at least one of the first color space and second color space digital image files prior to outputting of the second color space encoded digital image file associated therewith.

28. The computer implemented method for gray component replacement in a first color space to a second color space color conversion of claim 27 wherein:
the gray component replacement means includes at least a third gray component replacement scheme; and
the segmenting the first color space encoded digital signal further includes segmenting, in accordance with a unique spatial frequency range relative to every other spatial frequency range, the first color space encoded digital image file into at least a third image file segment communicated to the third gray component replacement scheme.

29. The computer implemented method for gray component replacement in a first color space to a second color space color conversion of claim 25, wherein the second color space includes a black component.

30. The computer implemented method for gray component replacement in a first color space to a second color space color conversion of claim 25, wherein the first color space is a cyan-magenta-yellow color space, and wherein the second color space is a cyan-magenta-yellow-black color space.

31. The computer implemented method for gray component replacement in a first color space to a second color space color conversion of claim 25, further comprising the steps of:
associating each of a plurality of pixels of the first color space image with one of the first and second image file segments; and
filtering the plurality of pixel groups based upon the association with one of the first and second image file segments.

32. The computer implemented method for gray component replacement in a first color space to a second color space color conversion of claim 31, further comprising the step of determining an amount of black colorant required for gray component replacement in each of the first and second gray component replacement schemes.
